(19) United States
(12) Patent Application Publication
(10) Pub. No.: US 2023/0139585 A1
(43) Pub. Date: May 4, 2023

(54) DETECTION APPARATUS AND METHOD

(71) Applicant: Ningbo ABAX Sensing Electronic Technology Co., Ltd., Ningbo City (CN)

(72) Inventor: Shuyu LEI, Ningbo City, Zhejiang Province (CN)

(73) Assignee: Ningbo ABAX Sensing Electronic Technology Co., Ltd., Ningbo City (CN)

(21) Appl. No.: 17/914,822

(22) PCT Filed: Sep. 29, 2020
(86) PCT No.: PCT/CN2020/118986

§ 371 Date: Sep. 27, 2022

(30) Foreign Application Priority Data
Apr. 1, 2020 (CN) 202010253020.5

(51) Int. Cl. G01S 17/89; G01S 7/481

(52) U.S. Cl. CPC G01S 17/89; G01S 7/4814; G01S 7/4816

(57) ABSTRACT

Provided are a detection apparatus and method. The detection apparatus comprises a light emitting module, a processing module and a light receiving module, the light emitting module comprises M emitting regions; the light receiving module comprises N receiving regions; M and N are both integers greater than zero; the M emitting regions output M paths of emitted light in a time-sharing manner; the N receiving regions receive reflected light information emitted by M emitting regions and reflected by a detection target in a time-sharing manner, and send the reflected light information and receiving time corresponding to the reflected light information to the processing module; and the processing module processes the received reflected light information, to synthesize a distance image with the image resolution not being less than the number N of receiving regions and not being greater than the product N×M of the receiving regions and the emitting regions.

### CROSS REFERENCE TO RELATED APPLICATIONS

This application claims priority to Chinese Patent Application No. CN202010253020.5, titled “DETECTION APPARATUS AND METHOD”, filed on Apr. 1, 2020 with the Chinese Patent Office, which is incorporated herein by reference in its entirety.

### FIELD

The present disclosure relates to the technical field of lidar, and in particular to a detection device and a detection method.

### BACKGROUND

With the development of the lidar technology, the Time of flight (TOF) technology has received more and more attention. The principle of the TOF is described as follows. A light pulse is continuously emitted to a target, and a light returned from the target is received by a sensor, and the distance to the target is obtained by detecting the flight (round-trip) time of the light pulse.

As the detection methods based on the TOF technology, the Direct Time of flight (DTOF) technology and the Indirect Time of flight (ITOF) technology have their own advantages in the use, and have received more and more attention.

However, in the existing distance measurement process, whether for the DTOF or the ITOF, the influence of the environment or other factors should be considered in the long-distance detection. The existing detection methods have the problem of low resolution of lidar distance measurement.

### SUMMARY

In view of the above, an object of the present disclosure is to provide a detection device and a detection method to improve the resolution of existing lidar distance measurement.

In order to achieve the above object, solutions in the embodiments of the present disclosure are provided.

In a first aspect, a detection device is provided according to an embodiment of the present disclosure. The detection device includes: a light emitting module, a processing module and a light receiving module. The light emitting module has M emitting regions, the light receiving module has N receiving regions, where M and N are each an integer greater than 0. The light emitting module is configured to output M channels of emitted light by the M emitting regions. The light receiving module is configured to: receive, by the N receiving regions, reflected light information of the emitted light emitted by the M emitting regions that is reflected from a detected target, and transmit the reflected light information and receiving time corresponding to the reflected light information to the processing module. The processing module is configured to generate an emitting order so that the emitting regions output the emitted light in accordance with the emitting order, where the light receiving module receives the reflected light information in accordance with the emitting order, and the processing module is further configured to acquire, in accordance with the emitting order, the reflected light information and the receiving time corresponding to the reflected light information, a distance image with an image resolution that is not lower than the number N of the receiving regions and that does not exceed N×M obtained by multiplying the number of the receiving regions and the number of the emitting regions.

Optionally, each of the emitting regions includes K sub emitting regions, each of the sub emitting regions includes at least one emitting unit, M is equal to N, and K is an integer greater than 0. The light emitting module is configured to cyclically perform the emitting for K times in accordance with the emitting order of the emitting units to sequentially output M×K channels of emitted light by M×K sub emitting regions. The light receiving module is further configured to: cyclically perform, by the N receiving regions, the receiving for K times to receive M×K channels of reflected light information of the emitted light reflected from the detected target, and transmit the reflected light information and receiving time corresponding to the reflected light information to the processing module. The processing module is configured to acquire the distance image with an image resolution not exceeding N×K in accordance with the emitting order, the reflected light information, and the receiving time corresponding to the reflected light information.

Optionally, the light emitting module includes at least one emitting array, and the number of columns of the emitting array is M; and the light receiving module includes at least one receiving array, and the number of rows of the receiving array is N.

Optionally, the light emitting module includes at least one emitting array, and the number of rows of the emitting array is M; and the light receiving module includes at least one receiving array, and the number of columns of the receiving array is N.

Optionally, the light emitting module includes multiple emitting units, the light receiving module includes multiple receiving units, and at least two of the emitting units correspond to one of the receiving units in the light receiving module.

Optionally, at least two of the emitting units correspond to a same receiving unit in the light receiving module at different times, so that the reflected light information of the emitted light of the at least two of the emitting units that is reflected from the detected target is received by the same receiving unit.

Optionally, the number of the emitting units is greater than the number of the receiving units.

Optionally, at least one of the emitting regions corresponds to the N emitting regions in the light receiving module at a same time, and the processing module acquires the distance image with an image resolution not exceeding N×M by correspondence at different times.

Optionally, the processing module is further configured to: determine the emitting order of the M emitting regions, and transmit the emitting order to the light emitting module and the light receiving module.

Optionally, the processing module is configured to determine the emitting order of the M emitting regions according to a preset number sequence, a randomly generated sequence, or a sequence generated by using different function relation formulas.

In a second aspect, a detection method is provided according to an embodiment of the present disclosure. The detection method is applied to the detection device described in the first aspect. The detection method includes:
generating the emitting order;
outputting, in accordance with the emitting order, M channels of emitted light by the M emitting regions;
receiving, in accordance with the emitting order, reflected light information of the emitted light emitted by the M emitting regions that is reflected from the detected target; and
acquiring, in accordance with the emitting order, the reflected light information and the receiving time corresponding to the reflected light information, the distance image with an image resolution that is not lower than the number N of the receiving regions and that does not exceed N×M obtained by multiplying the number of the receiving regions and the number of the emitting regions.

Optionally, each of the emitting regions includes K sub emitting regions, each of the sub emitting regions includes at least one emitting unit, M is equal to N, and K is an integer greater than 0, where
the outputting, in accordance with the emitting order, M channels of emitted light by the M emitting regions includes: cyclically performing the emitting for K times in accordance with the emitting order of the emitting units to sequentially output M×K channels of emitted light by M×K sub emitting regions;
the receiving, in accordance with the emitting order, reflected light information of the emitted light emitted by the M emitting regions that is reflected from the detected target includes: cyclically performing, by the N receiving regions, the receiving for K times, to receive M×K channels of reflected light information of the emitted light reflected from the detected target; and
the acquiring, in accordance with the emitting order, the reflected light information and the receiving time corresponding to the reflected light information, the distance image with an image resolution that is not lower than the number N of the receiving regions and that does not exceed N×M obtained by multiplying the number of the receiving regions and the number of the emitting regions includes: acquiring the distance image with an image resolution not exceeding N×K in accordance with the emitting order, the reflected light information, and the receiving time corresponding to the reflected light information.

Optionally, the light emitting module includes at least one emitting array, and the number of columns of the emitting array is M; and the light receiving module includes at least one receiving array, and the number of rows of the receiving array is N.

Optionally, the light emitting module includes at least one emitting array, and the number of rows of the emitting array is M; and the light receiving module includes at least one receiving array, and the number of columns of the receiving array is N.

Optionally, the light emitting module includes multiple emitting units, the light receiving module includes multiple receiving units, and at least two of the emitting units correspond to one of the receiving units in the light receiving module.

Optionally, at least two of the emitting units correspond to a same receiving unit in the light receiving module at different times, so that the reflected light information of the emitted light of the at least two of the emitting units that is reflected from the detected target is received by the same receiving unit.

Optionally, the number of the emitting units is greater than the number of the receiving units.

Optionally, at least one of the emitting regions corresponds to the N emitting regions in the light receiving module at a same time, and the distance image with an image resolution not exceeding N×M is acquired by correspondence at different times.

Optionally, the detection method further includes: determining the emitting order of the M emitting regions, and transmitting the emitting order to the light emitting module and the light receiving module.

Optionally, the generating the emitting order includes: determining the emitting order of the M emitting regions according to a preset number sequence, a randomly generated sequence, or a sequence generated by using different functional relation formulas.

The present disclosure has the following beneficial effects.

A detection device and a detection method are provided according to the embodiments of the present disclosure. The detection device may includes: a light emitting module, a processing module, and a light receiving module. The light emitting module has M emitting regions, and the light receiving module has N receiving regions, where M and N are each an integer greater than 0. The processing module is configured to generate an emitting order. The emitting regions output the emitted light in accordance with the emitting order. The light receiving module receives reflected light information in accordance with the emitting order, and transmits the reflected light information and receiving time corresponding to the reflected light information to the processing module. The processing module can calculate the distance data of the detected target in accordance with the emitting order, the reflected light information and the receiving time corresponding to the reflected light information. In this process, the M emitting regions output the M channels of the emitted light in time division, the N receiving regions receive the reflected light information that is emitted by the M emitting regions and reflected by the detected target in time division, and transmit the reflected light information and the receiving time corresponding to the reflected light information to the processing module, so that the processing module can process the received reflected light information in accordance with the emitting order, the reflected light information and the receiving time corresponding to the reflected light information, to synthesize the distance image with the image resolution that is not lower than the number N of the receiving regions and that does not exceed N×M obtained by multiplying the number of the receiving regions and the number of the emitting regions. The distance measurement result for the detected target can be outputted according to the distance image, thereby improving the distance measurement accuracy.

### BRIEF DESCRIPTION OF THE DRAWINGS

In order to illustrate technical solutions of embodiments of the present disclosure more clearly, the drawings used for the embodiments are briefly introduced in the following. It should be understood that the drawings show only some embodiments of the present disclosure, and should not be regarded as a limitation of the scope. Other drawings may be obtained by those skilled in the art from these drawings without any creative work.

FIG. 1 is a schematic diagram showing functional modules of a detection device according to an embodiment of the present disclosure;

FIG. 2 is a schematic diagram showing detection of a detection device according to an embodiment of the present disclosure;

FIG. 3 is a schematic diagram showing detection of a detection device according to another embodiment of the present disclosure;

FIG. 4 is a schematic diagram showing detection of a detection device according to another embodiment of the present disclosure; and

FIG. 5 is a schematic flowchart of a detection method according to an embodiment of the present disclosure.

### DETAILED DESCRIPTION OF EMBODIMENTS

In order to make objects, technical solutions and advantages of the embodiments of the present disclosure clearer, the technical solutions in the embodiments of the present disclosure are clearly and completely described below with reference to the drawings in the embodiments of the present disclosure. Apparently, the described embodiments are some but not all embodiments of the present disclosure. Components of the embodiments generally described and illustrated in the drawings herein may be arranged and designed in a variety of different configurations.

Therefore, the following detailed description for the embodiments of the present disclosure provided in the drawings is not intended to limit the scope of the present disclosure as claimed, but is merely representative of selected embodiments of the present disclosure. Based on the embodiments in the present disclosure, all other embodiments obtained by those skilled in the art without creative work shall fall in the protection scope of the present disclosure.

It should be noted that, similar numerals and letters refer to similar items in the following drawings. Therefore, if an item is defined in a drawing, the item is not required to be further defined and explained in subsequent drawings.

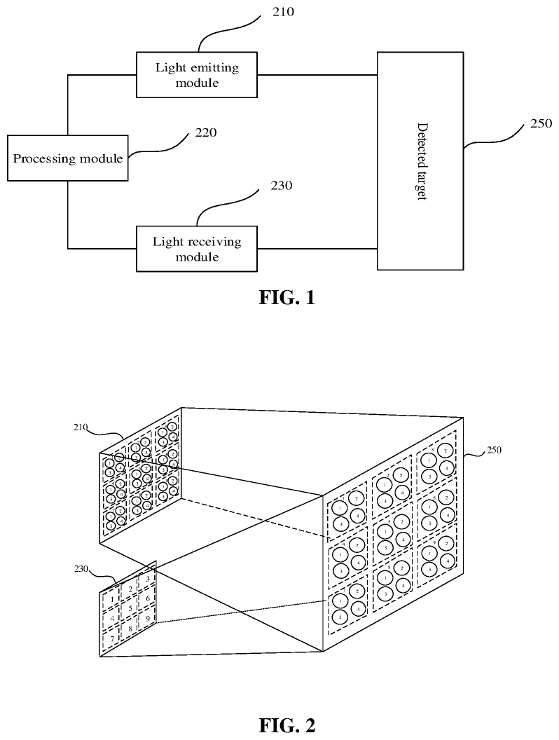

FIG. 1 is a schematic diagram showing functional modules of a detection device according to an embodiment of the present disclosure. As shown in FIG. 1, the detection device includes: a light emitting module 210, a processing module 220, and a light receiving module 230. The light emitting module 210 has M emitting regions, and the light receiving module 230 has N receiving regions, where M and N each are an integer greater than 0.

The light emitting module 210 is configured to output M channels of emitted light by the M emitting regions. The light receiving module 230 is configured to: receive, by the N receiving regions, reflected light information of the emitted light emitted by the M emitting regions that is reflected from a detected target, and transmit the reflected light information and receiving time corresponding to the reflected light information to the processing module 220.

In the embodiment of the present disclosure, the light emitting module 210 has the M emitting regions, which refer to that, a region for outputting the emitted light may be divided into M emitting regions, and M channels of the emitted light may be outputted through the M emitting regions. Further, the light receiving module 230 has the N receiving regions, which refer to that, a corresponding region for the receiving may be divided into N receiving regions, to receive the reflected light information of the emitted light emitted by the M emitting regions that is reflected from the detected target 250.

The values of M and N herein are not limited in the embodiments of the present disclosure. The M and N may correspond to pixel values of the emitting region and the receiving region, respectively. Therefore, the maximum image resolution of the distance image obtained in this way is N×M. Alternatively, the M and N may not correspond to the pixel values of the emitting region and the receiving region. For example, if the emitting region includes multiple sub emitting regions, the M may be the number of the sub emitting regions, and the N is the pixel value of the receiving region. The values of the M and N may be equal to each other. Optionally, the value of M may be set as 2, 5, 8, or the like, and the value of N may be set as 2, 5, 8, or the like. Alternatively, the M and N may not be equal to each other, which is not limited in the present disclosure. The actual application scenarios can be set flexibly.

The processing module 220 is configured to generate an emitting order, so that the emitting regions output the emitted light in accordance with the emitting order. The light receiving module 230 receives the reflected light information in accordance with the emitting order, and transmits the reflected light information and receiving time corresponding to the reflected light information to the processing module 220. In accordance with the emitting order, the reflected light information and the receiving time corresponding to the reflected light information, the processing module 220 acquires a distance image with an image resolution that is not lower than the number N of the receiving regions and that does not exceed N×M obtained by multiplying the number of the receiving regions and the number of the emitting regions.

After the light emitting module 210 receives the emitting order, the M emitting regions in the light emitting module 210 may output the emitted light in accordance with the emitting order. The outputted emitted light is reflected by the detected target 250, and the light receiving module 230 may receive, by the N receiving regions, the reflected light information that is emitted by the M emitting regions and reflected from the detected targets 250 in accordance with the emitting order, and transmit the reflected light information and the receiving time corresponding to the reflected light information to the processing module 220. The processing module 220 may calculate distance data of the detected target 250 according to the reflected light information and the receiving time corresponding to the reflected light information.

It should be noted that, the M emitting regions output the M channels of emitted light in accordance with the emitting order (for example, the emitting regions emit sequentially or randomly), and the N receiving regions receive the reflected light information of the channels of the emitted light that is reflected from the detected target 250 in accordance with the emitting order, and the light receiving module 230 transmits the reflected light information of each channel of the emitted light that is reflected from the detected target 250 and the corresponding receiving time to the processing module 220. In this case, for each channel of the outputted emitted light, the processing module 220 may acquire a distance image with an image resolution of N. Further, for the M channels of the outputted emitted light, the processing module 220 may acquire a distance image with an image resolution of N×M. Therefore, the processing module 220 may obtain a distance image with an image resolution that is not lower than the number N of the receiving regions and that does not exceed N×M obtained by multiplying the number of the receiving regions and the number of the emitting regions. That is, an image resolution higher than the number of the receiving regions can be obtained, improving the distance measurement accuracy of the detection device.

It should be noted that, according to the actual application scenario, the M emitting regions may be used to output X channels of the emitted light, where the value of X may be an integer greater than 0 and less than M. For example, if the value of M is 8, the value of X may be 6. In this case, the N receiving regions are used to receive the reflected light information that is emitted by the X emitting regions and reflected from the detected target 250, and the reflected light information and the receiving time corresponding to the reflected light information are transmitted to the processing module 220. The processing module 220 may obtain a distance image with an image resolution of N×X in accordance with the emitting order, the reflected light information, and the receiving time corresponding to the reflected light information. That is, a distance image with an image resolution that is not lower than the number N of the receiving regions and that does not exceed N×M obtained by multiplying the number of the receiving regions and the number of the emitting regions can be obtained.

To sum up, in the detection device according to the embodiment of the present disclosure, the detection device may include a light emitting module, a processing module, and a light receiving module. The light emitting module has M emitting regions, and the light receiving module has N receiving regions, where M and N each are an integer greater than 0. The processing module is configured to generate an emitting order. The emitting regions output the emitted light in accordance with the emitting order. The light receiving module receives reflected light information in accordance with the emitting order, and transmits the reflected light information and receiving time corresponding to the reflected light information to the processing module. The processing module can calculate the distance data of the detected target in accordance with the emitting order, the reflected light information and the receiving time corresponding to the reflected light information. In this process, the M emitting regions output the M channels of the emitted light in time division, the N receiving regions receive the reflected light information that is emitted by the M emitting regions and reflected by the detected target in time division, and transmit the reflected light information and the receiving time corresponding to the reflected light information to the processing module, so that the processing module can process the received reflected light information in accordance with the emitting order, the reflected light information and the receiving time corresponding to the reflected light information, to synthesize the distance image with the image resolution that is not lower than the number N of the receiving regions and that does not exceed N×M obtained by multiplying the number of the receiving regions and the number of the emitting regions. The distance measurement result for the detected target can be outputted according to the distance image, thereby improving the distance measurement accuracy.

Further, in the detection device according to the embodiment of the present disclosure, since the M emitting regions in the light emitting module output the emitted light in time division, the maximum instantaneous current generated when the emitted light is outputted can be reduced, so that the driving current can be more gentle, and the heat dissipation effect of the light emitting module can be improved. In addition, in the embodiment of the present disclosure, no other light receiving module is added while improving the resolution of the detection device. In this way, the size of the detection device can be reduced to a certain extent, and the applicability of the detection device can be improved. The detection device provided in the embodiment of the present disclosure can not only be applied to the long-distance detection mode, but also can be applied to the short-range detection mode by controlling some of the M emitting regions to output the emitted light according to the actual needs in the actual use process. For example, the output can be controlled to adapt to low-power detection at a short distance. In this mode, only a part of one emitting region performs the emitting once, and a distance image with an image resolution even lower than the number N of the receiving regions can be obtained, and further the corresponding detection result for the short distance can be obtained, which is not excluded in the present disclosure.

Optionally, each emitting region includes K sub emitting regions, each sub emitting region includes at least one emitting unit, where M is equal to N, and K is an integer greater than 0. The light emitting module 210 is configured to cyclically perform the emitting for K times in accordance with the emitting order of the emitting units to sequentially output M×K channels of emitted light by M×K sub emitting regions. Correspondingly, the light receiving module 230 is further configured to: cyclically perform, by the N receiving regions, the receiving for K times to receive M×K channels of reflected light information of the emitted light reflected from the detected target 250, and transmit each channel of the reflected light information and receiving time corresponding to the reflected light information to the processing module 220. The processing module 220 is configured to acquire the distance image with an image resolution not exceeding N×K in accordance with the emitting order, the reflected light information, and the receiving time corresponding to the reflected light information.

The number of the light receiving regions is N. In this case, if a distance image with an image resolution greater than the number N of the receiving regions is required, the light emitting module 210 may be divided into M emitting regions, where the value of M may be the same as N. Each emitting region may include K sub emitting regions. The processing module 220 may acquire a distance image with an image resolution not exceeding N×K, which may be obtained by the following process. It should further be noted that, the emitting order in the present disclosure may be an emitting order of the emitting regions according to the division method of the light emitting module 210. If the emitting region includes at least one sub emitting region, the emitting order may be an emitting order of the sub emitting regions. In addition, if each sub emitting region includes at least one emitting unit, the emitting order may be an emitting order of the emitting units, which is not limited in the present disclosure.

The above process may also be understood as a process of dividing the emitting region into N corresponding emitting regions according to the pixel of the receiving region, where each emitting region includes K sub emitting regions, and each sub emitting region includes at least one emitting unit, and the emitting units of the K sub emitting regions are encoded. Optionally, the emitting units with the same encoding in all the sub emitting regions form one emitting region, and thus all the emitting units form a total of M emitting regions. The M emitting regions emit the emitted light sequentially or randomly in accordance with the emitting order generated by the processing module 220. In practice, if one of the M emitting regions emits once, the processing module 220 may obtain a distance image with an image resolution of N. Further, if all the M emitting regions emit to output M channels of the emitted light, the processing module 220 may obtain M times of emission results, and further obtain a distance image with a maximum image resolution of M×N. As described above, a part of one emitting region among the M emitting regions emits once, so that a distance image with an image resolution lower than N can be obtained, to achieve a short-range and low-power detection effect.

FIG. 2 is a schematic diagram showing detection of a detection device according to an embodiment of the present disclosure. The values of M, N, and K may be respectively 9, 9, and 4. As shown in FIG. 2, the light emitting module 210 may include 9 emitting regions, and each emitting region includes 4 sub emitting regions, which may be numbered 1, 2, 3, and 4 in turn, and each sub emitting region includes at least one emitting unit (for example, an emitting pixel). The light emitting module 210 is specifically configured to: cyclically perform the emitting for 4 times in accordance with the emitting order of the emitting units (for example, sequentially emit in the order of 1→2→3→4) to sequentially output 9*4 channels of the emitted light by 9*4 sub emitting regions. Correspondingly, the light receiving module 230 is further configured to cyclically perform, by the 9 receiving regions, the receiving for 4 times to receive 9*4 channels of reflected light information of the emitted light reflected from the detected target 250, and transmit the reflected light information of each channel and receiving time corresponding to the reflected light information to the processing module 220. The processing module 220 may acquire a distance image with an image resolution not exceeding 9*4 according to the reflected light information of each channel and the receiving time corresponding to the reflected light information.

According to the above, it can be understood that the number of receiving regions is 9=3*3, but the number of emitting units is 36=6*6. Therefore, the emitting region of the light emitting module 210 may be divided into 9=3*3 emitting regions according to the number of receiving regions. There are 4 emitting units in each emitting region, and the emitting units are encoded (by different encoding methods to form different patterns or by random encoding, which is not limited in the present disclosure). The emitting units having the same encoding in different emitting regions reform an emitting region, so that the emitting region of the light emitting module 210 is finally divided into 4 emitting regions. The 4 emitting regions may output the emitted light in the manner described above, and further the processing module 200 may obtain a distance image with an image resolution not lower than 9=3*3, and also may obtain a distance image with an image resolution up to 36=9*4=(3*3)*4. The above is just an exemplary description. In practice, the values of N and M may be set according to the usage situation, to achieve the effect of super-resolution according to the specific situation.

Optionally, the light emitting module 210 includes at least one emitting array, and the number of columns of the emitting array is M; and the light receiving module 230 includes at least one receiving array, and the number of rows of the receiving array is N (each column of the emitting array may contain at least one emitting unit, each row of the receiving array may contain at least one receiving unit). The following description is given for a special case, for example, a case that each column of the emitting array contains only one emitting unit and each row of the receiving array contains only one receiving unit. The case of each column or row containing more than one emitting unit or receiving unit is similar to the case of each column or row containing only one emitting unit or receiving unit, which is not repeated in the present disclosure.

The light emitting module 210 includes at least one emitting array. In the case of dividing the emitting array according to the pixel value, the emitting array may be an emitting array having 1×M pixels, that is, a row pixel of the emitting array may be 1, and a column pixel of the emitting array may be M, and the light emitting module 210 performs divisional emission by M emitting regions. Correspondingly, the light receiving module 230 may include at least one receiving array, and the receiving array may be an emitting array having N×1 pixels, that is, a row pixel of the receiving array may be N, and a column pixel of the receiving array may be 1, and the light receiving module 230 performs divisional emission by N receiving regions.

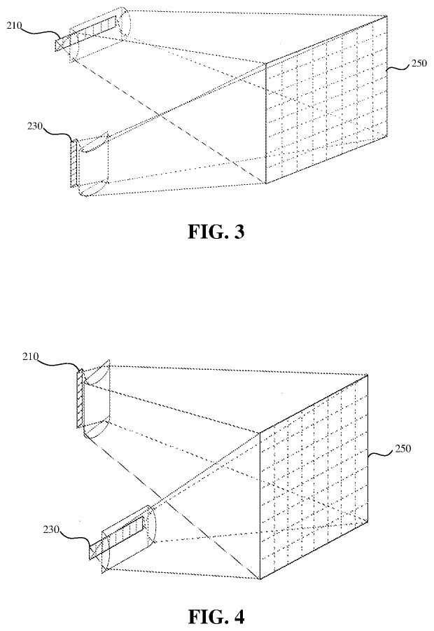

FIG. 3 is a schematic diagram showing detection of a detection device according to another embodiment of the present disclosure. As shown in FIG. 3, the emitting array may be divided into M emitting regions from left to right, each emitting region contains a emitting units. Further, the receiving array may be divided into N receiving regions from top to bottom, and each receiving region contains b receiving units. For the emitting array, the M emitting regions may output M channels of emitted light in accordance with the emitting order (for example, sequentially or randomly). It should be noted that, in the case that the M emitting regions output the emitted light, only one emitting region outputs the emitted light each time. For example, the emitted light outputted by an emitting region i may be received by the N receiving regions of the receiving array after being reflected on the detected target 250, to obtain a column vector with a dimension of N×1. The column vector may represent the reflected light information of the emitted light outputted from this emitting region that is reflected from the detected target 250. According to the reflected light information, image information of an i-th column in the distance image with the image resolution of N×M may be determined. Based on the above process, each of the M emitting regions performs the emission until all emitting regions output the emitted light, and the N receiving regions are used to receive the corresponding reflected light information. Finally, in accordance with the emitting order of the M emitting regions, the reflected light information, and the receiving time corresponding to the reflected light information, the processing module 220 can determine the image information of each column in the distance image with the image resolution of N×M, to finally obtain a complete distance image with the image resolution of N×M.

Optionally, the light emitting module 210 includes at least one emitting array, and the number of rows of the emitting array is M; and the light receiving module 230 includes at least one receiving array, and the number of columns of the receiving array is N (each row of the emitting array may contain at least one emitting unit, each column of the receiving array may contain at least one receiving unit). The following description is given for a special case, for example, a case that each row of the emitting array contains only one emitting unit and each column of the receiving array contains only one receiving unit. The case of each row or column containing more than one emitting unit or receiving unit is similar to the case of each row or column containing only one emitting unit or receiving unit, which is not repeated in the present disclosure.

In the case of dividing the emitting array according to the pixel value, the emitting array may be an emitting array having M×1 pixels, that is, a row pixel of the emitting array may be M, and a column pixel of the emitting pixel may be 1, and the light emitting module 210 performs divisional emission by M emitting regions. Correspondingly, the light receiving module 230 may include at least one receiving array, and the receiving array may be a receiving array having 1×N pixels, that is, a row pixel of the receiving array may be 1, and a column pixel of the receiving array may be N, and the light receiving module 230 performs divisional emission by N receiving regions. For such a division manner, reference may be made to the relevant parts of the above method embodiments, and details thereof are not repeated herein in the present disclosure.

FIG. 4 is a schematic diagram showing detection of a detection device according to another embodiment of the present disclosure. As shown in FIG. 4, the emitting array may be divided into M emitting regions from top to bottom, each emitting region contains a emitting units. Further, the receiving array may be divided into N receiving regions from left to right, and each receiving region contains b receiving units. For the emitting array, the M emitting regions may output M channels of emitted light in accordance with the emitting order (for example, sequentially or randomly). It should be noted that, in the case that the M emitting regions output the emitted light, only one emitting region outputs the emitted light each time. For example, the emitted light outputted by an emitting region j may be received by the N receiving regions of the receiving array after being reflected on the detected target 250, to obtain a row vector with a dimension of 1×N. The row vector may represent the reflected light information of the emitted light outputted from this emitting region that is reflected from the detected target 250. According to the reflected light information, image information of a j-th row in the distance image with the image resolution of M×N may be determined. Based on the above process, each of the M emitting regions performs the emission until all emitting regions output the emitted light, and the N receiving regions are used to receive the corresponding reflected light information. Finally, in accordance with the emitting order of the M emitting regions, the reflected light information, and the receiving time corresponding to the reflected light information, the processing module 220 can determine the image information of each row in the distance image with the image resolution of M×N, to finally obtain a complete distance image with the image resolution of M×N.

It should be noted that the values of a and b described above may be the same or different, which may be 1 or more than 1.

Optionally, the light emitting module 210 includes multiple emitting units, the light receiving module 230 includes multiple receiving units, and at least two of the emitting units correspond to one of the receiving units in the light receiving module 230.

Optionally, at least two of the emitting units correspond to the same receiving unit in the light receiving module 230 at different times, so that the reflected light information of the emitted light of the at least two of the emitting units that is reflected from the detected target 250 is received by the same receiving unit.

The emitting unit may be a semiconductor laser or a solid-state laser, and may also be an emitting pixel, or the like. The receiving unit may include a photodiode array or an avalanche photodiode array, or the like, which is not limited in the present disclosure.

It should be noted that, each emitting region may include one or more emitting units, and each receiving region may include one or more receiving units. As shown in FIG. 2, the light emitting module 210 may include 9 emitting regions, each emitting region includes 4 sub emitting regions, and each sub emitting region includes one emitting unit (for example, an emitting pixel), The emitting units in each sub emitting region are numbered 1, 2, 3 and 4 in turn. The light receiving module 230 may include 9 receiving regions, and each receiving region includes one receiving unit.

If the emitting units sequentially emit in the emitting order of 1→2→3→4, optionally, the light emitting module 210 may control the emitting unit with the emission number 1 in each emitting region to output the emitted light in accordance with the emitting order. In this case, 9 channels of the emitted light are outputted, and the 9 channels of the emitted light are reflected by the detected target 250 to generate reflected light information. Next, the 9 channels of reflected light information may be correspondingly received by the 9 receiving units of the light receiving module 230.

It should be noted that, the receiving units may be divided according to the number of sub emitting regions included in each emitting region. For example, in the embodiment of the present disclosure, the receiving region of each receiving unit may be divided into 4 sub receiving regions, which may be numbered, for example, 1, 2, 3, and 4. Each sub receiving region correspondingly receives the reflected light information of the emitted light emitted by one sub emitting region that is reflected from the detected target 250, that is, the sub receiving region numbered 1 in each receiving region correspondingly receives the reflected light information of the emitted light emitted by the sub emitting region numbered 1 in the emitting region that is reflected from the detected target 250. According to the above process, the emitting unit numbered 2 in each emitting region outputs the emitted light, and the sub receiving region numbered 2 in the receiving region correspondingly the reflected light information of the emitted light emitted by the sub emitting region numbered 2 in the emitting region that is reflected from the detected target 250. In this way, the light emitting module 210 can output 9*4 channels of the emitted light by the emitting for 4 times. The following description is given by taking a first emitting region as an example. The first emitting region includes 4 sub emitting regions, and each sub emitting region includes one emitting unit. That is, the first emitting region includes 4 emitting units, and the reflected light information of the emitted light outputted by the 4 emitting units that is reflected from the detected target 250 may all be received by the first receiving region. This receiving region includes one receiving unit, so that at least two emitting units corresponds to one receiving unit in the light receiving module 230, achieving the sharing of the receiving unit. The processing module 220 may obtain the image information with a resolution not lower than the number N of the receiving regions and not exceeding N×M obtained by multiplying the number of the receiving regions and the number of the emitting regions, and obtains a distance measurement accuracy higher than the number of pixels of the light receiving module 230, improving the resolution of lidar distance measurement.

Optionally, the number of the emitting units is greater than the number of the receiving units.

It should further be noted that the number of emitting units in the light emitting module 210 and the number of receiving units in the light receiving module 230 are not limited in the present disclosure. Optionally, the number of the emitting units may be greater than the number of the receiving units. As described in the above embodiments, the number of emitting units in the light emitting module 210 may be 36, the number of receiving units in the light receiving module 230 may be 9, and the number of the emitting units is greater than the number of the receiving units, but is not limited thereto, which may be flexibly set according to the actual application scenarios.

Optionally, at least one of the emitting regions corresponds to the N emitting regions in the light receiving module 230 at a same time, and through the correspondence at different times, the processing module 220 acquires the distance image with an image resolution not exceeding N×M by correspondence at different times.

At least one emitting region corresponds to N emitting regions in the light receiving module 230 at the same time, that is, the reflected light information of the emitted light outputted by the at least one emitting region at the same time that is reflected from the detected target 250 may be received by the N emitting regions in the light receiving module 230. The light receiving module 230 may transmit the reflected light information and the receiving time corresponding to the reflected light information to the processing module 220. In this way, by the correspondence at different times, the processing module 220 can obtain image information with a resolution not exceeding N×M.

Optionally, the processing module 220 is further configured to: determine the emitting order of the M emitting regions, and transmit the emitting order to the light emitting module and the light receiving module 230.

The emitting order of the emitting regions may be determined by the processing module 220. The emitting order may be performing the emitting randomly, sequentially, or the like, but not limited thereto. Other emitting orders may be adopted according to the actual application scenarios.

Optionally, the processing module 220 is configured to determine the emission order of the M emitting regions according to a preset number sequence, a randomly generated sequence, or a sequence generated by using different function relation formulas.

It should be noted that the method of determining the emitting order is not limited to that described above. In the actual application, the emitting order may be inputted by means of user input, so that the requirements for the emitting order of the light emitting module 210 in different application scenarios can be met, to improve the applicability of the detection device.

Optionally, the determined emitting order may be performing the emitting sequentially, according to a preset rule, or randomly. For example, in the case that the light emitting module 210 includes 6 emitting regions, the corresponding emitting order may be performing the emitting sequentially in the order of 1 [symbol] 2 [symbol] 3 [symbol] 4 [symbol] 5 [symbol] 6. That is, the emitting region numbered 1 outputs the emitted light firstly, and the emitting regions respectively numbered 2, 3, 4, 5 and 6 output the emitted light. In addition, the emitting order may be performing the emitting according to a preset rule of 1 [symbol] 3 [symbol] 5 [symbol] 2 [symbol] 4 [symbol] 6. That is, the emitting regions numbered odd (1, 3 and 5) firstly perform the emitting, next the emitting regions numbered even (2, 4 and 6) perform the emitting. In addition, the emitting may be performed randomly in the order of 1 [symbol] 2 [symbol] 5 [symbol] 6 [symbol] 3 [symbol] 4, which is not limited in the present disclosure and may be determined according to the actual application scenarios.

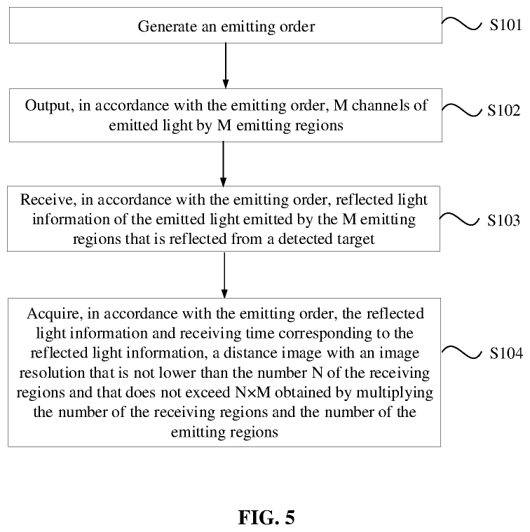

FIG. 5 is a schematic flowchart of a detection method according to an embodiment of the present disclosure. The detection method may be applied to the detection device described above. The basic principle and technical effect of the method are the same as those of the corresponding device embodiment described above. For parts not mentioned in the embodiment, reference may be made to the corresponding content in the embodiment of the detection device. As shown in FIG. 5, the detection method may include the following steps S101 to S104.

In S101, an emitting order is generated.

In S102, M channels of emitted light is outputted by M emitting regions in accordance with the emitting order.

In S103, in accordance with the emitting order, reflected light information of the emitted light emitted by the M emitting regions that is reflected from a detected target is received.

In S104, in accordance with the emitting order, the reflected light information, and receiving time corresponding to the reflected light information, a distance image with an image resolution that is not lower than the number N of the receiving regions and that does not exceed N×M obtained by multiplying the number of the receiving regions and the number of the emitting regions is acquired.

Optionally, each of the emitting region includes K sub emitting regions, each of the sub emitting regions includes at least one emitting unit, M is equal to N, and K is an integer greater than 0, where
the process of outputting, in accordance with the emitting order, M channels of emitted light by the M emitting regions includes: cyclically performing the emitting for K times in accordance with the emitting order of the emitting units to sequentially output M×K channels of emitted light by M×K sub emitting regions;
the process of receiving, in accordance with the emitting order, reflected light information of the emitted light emitted by the M emitting regions that is reflected from the detected target includes: cyclically performing, by the N receiving regions, the receiving for K times, to receive M×K channels of reflected light information of the emitted light reflected from the detected target; and
the process of acquiring, in accordance with the emitting order, the reflected light information and the receiving time corresponding to the reflected light information, the distance image with an image resolution that is not lower than the number N of the receiving regions and that does not exceed N×M obtained by multiplying the number of the receiving regions and the number of the emitting regions includes: acquiring the distance image with an image resolution not exceeding N×K in accordance with the emitting order, the reflected light information, and the receiving time corresponding to the reflected light information.

Optionally, the light emitting module includes at least one emitting array, and the number of columns of the emitting array is M; and the light receiving module includes at least one receiving array, and the number of rows of the receiving array is N.

Optionally, the light emitting module includes at least one emitting array, and the number of rows of the emitting array is M; and the light receiving module includes at least one receiving array, and the number of columns of the receiving array is N.

Optionally, the light emitting module includes multiple emitting units, the light receiving module includes multiple receiving units, and at least two of the emitting units correspond to one of the receiving units in the light receiving module.

Optionally, at least two of the emitting units correspond to the same receiving unit in the light receiving module at different times, so that the reflected light information of the emitted light of the at least two of the emitting units that is reflected from the detected target is received by the same receiving unit.

Optionally, the number of the emitting units is greater than the number of the receiving units.

Optionally, at least one of the emitting regions corresponds to N emitting regions in the light receiving module at a same time, and the processing module acquires the distance image with an image resolution not exceeding N×M by correspondence at different times.

Optionally, the method further includes: determining the emitting order of the M emitting regions, and transmitting the emitting order to the light emitting module and the light receiving module.

Optionally, the process of generating the emitting order includes:
determining the emitting order of the M emitting regions according to a preset number sequence, a randomly generated sequence, or a sequence generated by using different functional relation formulas.

The above method is applied to the detection device provided in the above embodiments, and the implementation principle and technical effect thereof are similar, which are not repeated herein.

It should be noted that, terms “comprising”, “including” or any other variations thereof are intended to encompass a non-exclusive inclusion, such that a process, a method, an article or a device including a series of elements includes not only those elements, but also includes other elements that are not explicitly listed or inherent to such the process, method, article or device. Without further limitation, an element defined by a phrase “including a . . . ” does not preclude the presence of additional identical elements in a process, method, article or device including the element.

Preferred embodiments of the present disclosure are given in the above description, and are not intended to limit the present disclosure. For those skilled in the art, the present disclosure may have various modifications and changes. Any modifications, equivalents and improvements made in the spirit and principle of the present disclosure should be included in the protection scope of the present disclosure. It should be noted that similar numerals and letters refer to similar items in the following drawings. Therefore, if an item is defined in a drawing, the item is not required to be further defined and explained in subsequent drawings. Preferred embodiments of the present disclosure are given in the above description, and are not intended to limit the present disclosure. For those skilled in the art, the present disclosure may have various modifications and changes. Any modifications, equivalents and improvements made in the spirit and principle of the present disclosure should be included in the protection scope of the present disclosure.

1. A detection device, comprising: a light emitting module, a processing module, and a light receiving module, the light emitting module having M emitting regions, the light receiving module having N receiving regions, M and N being each an integer greater than 0, wherein
the light emitting module is configured to output M channels of emitted light by the M emitting regions;
the light receiving module is configured to: receive, by the N receiving regions, reflected light information of the emitted light emitted by the M emitting regions that is reflected from a detected target, and transmit the reflected light information and receiving time corresponding to the reflected light information to the processing module; and
the processing module is configured to generate an emitting order so that the emitting regions output the emitted light in accordance with the emitting order, wherein the light receiving module receives the reflected light information in accordance with the emitting order, and the processing module is further configured to acquire, in accordance with the emitting order, the reflected light information and the receiving time corresponding to the reflected light information, a distance image with an image resolution that is not lower than the number N of the receiving regions and that does not exceed N×M obtained by multiplying the number of the receiving regions and the number of the emitting regions.

2. The detection device according to claim 1, wherein each of the emitting regions comprises K sub emitting regions, each of the sub emitting regions comprises at least one emitting unit, M is equal to N, and K is an integer greater than 0, and wherein
the light emitting module is configured to cyclically perform the emitting for K times in accordance with the emitting order of the emitting units to sequentially output M×K channels of emitted light by M×K sub emitting regions;
the light receiving module is further configured to: cyclically perform, by the N receiving regions, the receiving for K times to receive M×K channels of reflected light information of the emitted light reflected from the detected target, and transmit the reflected light information and receiving time corresponding to the reflected light information to the processing module; and
the processing module is configured to acquire the distance image with an image resolution not exceeding N×K in accordance with the emitting order, the reflected light information, and the receiving time corresponding to the reflected light information.

3. The detection device according to claim 1, wherein
the light emitting module comprises at least one emitting array, and the number of columns of the emitting array is M; and
the light receiving module comprises at least one receiving array, and the number of rows of the receiving array is N.

4. The detection device according to claim 1, wherein
the light emitting module comprises at least one emitting array, and the number of rows of the emitting array is M; and
the light receiving module comprises at least one receiving array, and the number of columns of the receiving array is N.

5. The detection device according to claim 1, wherein the light emitting module comprises a plurality of emitting units, the light receiving module comprises a plurality of receiving units, and at least two of the emitting units correspond to one of the receiving units in the light receiving module.

6. The detection device according to claim 5, wherein at least two of the emitting units correspond to a same receiving unit in the light receiving module at different times, so that the reflected light information of the emitted light of the at least two of the emitting units that is reflected from the detected target is received by the same receiving unit.

7. The detection device according to claim 5, wherein the number of the emitting units is greater than the number of the receiving units.

8. The detection device according to claim 3, wherein at least one of the emitting regions corresponds to the N receiving regions in the light receiving module at a same time, and the processing module acquires the distance image with an image resolution not exceeding N×M by correspondence at different times.

9. The detection device according to claim 1, wherein the processing module is further configured to: determine the emitting order of the M emitting regions, and transmit the emitting order to the light emitting module and the light receiving module.

10. The detection device according to claim 1, wherein the processing module is configured to determine the emitting order of the M emitting regions according to a preset number sequence, a randomly generated sequence, or a sequence generated by using different function relation formulas.

11. A detection method, applied to the detection device according to claim 1, the detection method comprising:
generating the emitting order;
outputting, in accordance with the emitting order, M channels of emitted light by the M emitting regions;
receiving, in accordance with the emitting order, reflected light information of the emitted light emitted by the M emitting regions that is reflected from the detected target; and
acquiring, in accordance with the emitting order, the reflected light information and the receiving time corresponding to the reflected light information, the distance image with an image resolution that is not lower than the number N of the receiving regions and that does not exceed N×M obtained by multiplying the number of the receiving regions and the number of the emitting regions.

12. The detection method according to claim 11, wherein each of the emitting regions comprises K sub emitting regions, each of the sub emitting regions comprises at least one emitting unit, M is equal to N, and K is an integer greater than 0, and wherein
the outputting, in accordance with the emitting order, M channels of emitted light by the M emitting regions comprises:
cyclically performing the emitting for K times in accordance with the emitting order of the emitting units to sequentially output M×K channels of emitted light by M×K sub emitting regions;
the receiving, in accordance with the emitting order, reflected light information of the emitted light emitted by the M emitting regions that is reflected from the detected target comprises:
cyclically performing, by the N receiving regions, the receiving for K times, to receive M×K channels of reflected light information of the emitted light reflected from the detected target; and
the acquiring, in accordance with the emitting order, the reflected light information and the receiving time corresponding to the reflected light information, the distance image with an image resolution that is not lower than the number N of the receiving regions and that does not exceed N×M obtained by multiplying the number of the receiving regions and the number of the emitting regions comprises:
acquiring the distance image with an image resolution not exceeding N×K in accordance with the emitting order, the reflected light information, and the receiving time corresponding to the reflected light information.

13. The detection method according to claim 11, wherein
the light emitting module comprises at least one emitting array, and the number of columns of the emitting array is M; and
the light receiving module comprises at least one receiving array, and the number of rows of the receiving array is N.

14. The detection method according to claim 11, wherein
the light emitting module comprises at least one emitting array, and the number of rows of the emitting array is M; and
the light receiving module comprises at least one receiving array, and the number of columns of the receiving array is N.

15. The detection method according to claim 11, wherein the light emitting module comprises a plurality of emitting units, the light receiving module comprises a plurality of receiving units, and at least two of the emitting units correspond to one of the receiving units in the light receiving module.

16. The detection method according to claim 15, wherein at least two of the emitting units correspond to a same receiving unit in the light receiving module at different times, so that the reflected light information of the emitted light of the at least two of the emitting units that is reflected from the detected target is received by the same receiving unit.

17. The detection method according to claim 15, wherein the number of the emitting units is greater than the number of the receiving units.

18. The detection method according to claim 13, wherein at least one of the emitting regions corresponds to the N receiving regions in the light receiving module at a same time, and the distance image with an image resolution not exceeding N×M is acquired by correspondence at different times.

19. The detection method according to claim 11, further comprising:
determining the emitting order of the M emitting regions, and transmitting the emitting order to the light emitting module and the light receiving module.

20. The detection method according to claim 11, wherein the generating the emitting order comprises:
determining the emitting order of the M emitting regions according to a preset number sequence, a randomly generated sequence, or a sequence generated by using different functional relation formulas.
